(19) United States
(12) Patent Application Publication
(10) Pub. No.: US 2015/0227837 A1
(43) Pub. Date: Aug. 13, 2015

(54) SYSTEM MONITORING

(71) Applicant: ISIS INNOVATION LIMITED, Oxford, Oxfordshire (GB)

(72) Inventors: David Andrew Clifton, Oxford (GB); Lionel Tarassenko, Oxford (GB); Samuel Hugueny, Oxford (GB)

(73) Assignee: ISIS INNOVATION LIMITED, Oxford, Oxfordshire (GB)

(21) Appl. No.: 14/425,521

(22) PCT Filed: Aug. 22, 2013
(86) PCT No.: PCT/GB2013/052219

§ 371 Date: Mar. 3, 2015

(30) Foreign Application Priority Data
Sep. 3, 2012 (GB) 1215649.3

(51) Int. Cl. G06N 5/04; G06N 7/00

(52) U.S. Cl. CPC G06N 5/04; G06N 7/005

(57) ABSTRACT

A method of monitoring a system such as a machine, industrial system, or human or animal patient, to classify the system as normal or abnormal, in which a time-series of measurements of the system are regarded as a function to be compared to a model of normality for such functions. The model of normality can be constructed as a Gaussian Process and test functions compared to the model to derive the probability that they are drawn from the model of normality. A probability distribution for the expected extrema of sets of functions drawn from the model can also be derived and the probability of any extremum of a plurality of test functions being an extremum of a set derived from the model of normality can be obtained. The system can be classified as normal or abnormal based on the extreme probability distribution. Test functions with fewer data points can be compared to the model of normality by marginalisation with respect to the missing data points.

The present invention relates to the field of systems monitoring and in particular to the automated analysis of the state of a system.

Systems monitoring is applicable to fields as diverse as the monitoring of machines, the monitoring of industrial plants, and the monitoring of human or animal patient's vital signs in the medical and veterinary field, and typically such monitoring is conducted by measuring the state of the system using a sensor or sensors measuring some parameter or variable of the system. To assist in the interpretation of the signals acquired from complex systems, developments over the last few decades have led to automated analysis of the signals with a view to issuing an alarm to a human user or operator if the state of the system departs from normality. A basic and traditional approach to this has been to apply a threshold to the sensor signals, with the alarm being triggered if any, or a combination of, these single-channel thresholds is breached. However, it is often difficult to set such thresholds automatically at a point which on the one hand provides a sufficiently safe margin by alarming reliably when the system departs from normality, but on the other hand does not generate too many false alarms, which leads to alarms being ignored.

Consequently more recently techniques have been developed which assess the state of a system relative to a model of normal system condition, with a view to classifying data from the sensors as normal or abnormal with respect to the model. Such novelty detection, or 1-class classification, is particularly well-suited to problems in which a large quantity of examples of normal behaviour exist, such that a model of normality may be constructed, but where examples of abnormal behaviour are rare, such that a traditional multi-class approach cannot be taken. Novelty detection is therefore useful in the analysis of data from safety-critical systems such as jet engines, manufacturing processes, or power-generation facilities, which spend the majority of their operational life in a normal state, and which exhibit few, if any, failure conditions. It is also applicable, though, in the medical and veterinary field, where human/animal vital signs are treated in the same way as data acquired from mechanical systems.

As indicated above, novelty detection is performed with respect to a model of normality for the system. Such a model can typically be produced by taking a set of measurements of the system while it is assumed or known (e.g. by expert judgement) to be in a state regarded as normal (these measurements then being known as the training set) and fitting some analytical function to the data. For example, for multivariate and multimodal data the function could be a Gaussian Mixture Model (GMM), Parzen Window Estimator, or other mixture of kernel functions. In this context, multivariate means that there are a plurality of variables for example each variable corresponds to a measurement obtained from a single sensor (or some feature derived from a sensor measurement), or some single parameter of the system and multimodal means that the function has more than one mode (i.e. more than one local maximum in the probability distribution function that describes the distribution of values in the training set). The model of normality can therefore be represented as a probability density function p(x) (the GMM or other function fitted to the training set) over a multidimensional space with each dimension of the vector (x) corresponding to an individual variable or parameter of the system.

Having constructed such a model of normality one approach to novelty detection is simply to set a novelty threshold on the probability density function such that a data point x is classified as abnormal if the probability density p(x) is less than the threshold. Such thresholds are simply set so that the separation between normal and any abnormal data is maximised on a large validation data set, containing examples of both normal and abnormal data labelled by system domain experts. A similar alternative approach is to consider the cumulative probability function P(x) associated with the probability distribution: that is to find the probability mass P obtained by integrating the probability density function p(x) up to the novelty threshold and to set the threshold at that probability density which results in the desired integral value P (for example so that 99% of the data is classified normal with respect to the threshold). This allows a probabilistic interpretation, namely: if one were to draw a single sample from the model, it would be expected to lie outside the novelty threshold with a probability 1-P. For example, if the threshold were set such that P is 0.99, so that 99% of single samples could be expected to be classified normal, then 1-P is 0.01, and 1% of single samples would expected to be classified abnormal with respect to that threshold.

However, these approaches are essentially pointwise in that each of the test points x (i.e. the state of the system as defined by a sensor reading or several different sensor readings at any particular time) are classified independently from one another by being compared to the novelty threshold. When continually monitoring a system, a time-series of measurements is generated and the assumption which is intrinsic in the pointwise approach, namely that each point is independent of each other point, can result in a large number of misclassifications of the system because a large number of assumedly independent decisions are being made (perhaps at the sampling rate of the data). There is no assessment of whether the time-series (taken as a whole series) is indicative of normality or abnormality. The conventional pointwise approach would not, therefore, be able to classify a system as abnormal if the abnormality is creating an unusual time variation in the time-series of data without generating any single data point which exceeds the novelty threshold. One way of attempting to mitigate this problem is to classify the system as abnormal only if a threshold is exceeded for a certain time period, but this is still assessing each measurement in the time-series independently against the threshold.

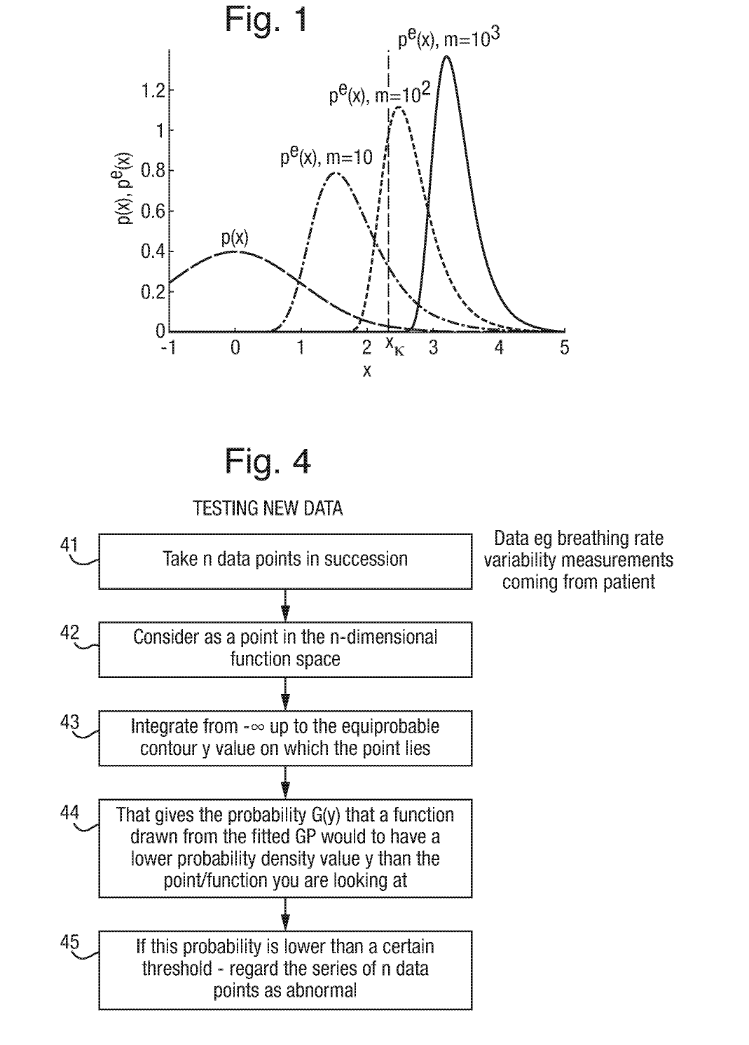

An additional problem with continual systems monitoring, which naturally generates large quantities of data, is that the longer one monitors a system the more likely one is to see extreme values of variables, despite the system being in a normal state. The extrema of a large data set are likely to be more extreme than the extrema of a small data set. This means that even though the system is normal, an extremum of a large data set is quite likely to trigger a false alarm by exceeding the threshold, and the situation gets worse as more readings are taken. Because of this, interest has developed in using extreme value theory in the monitoring of systems, for example in the engineering, health and finance fields as disclosed in WO-A-2011-023924. Extreme value theory is a branch of statistics concerned with modelling the distribution of very large or very small values (extrema) with respect to the probability distribution function describing the location of the normal data. Extreme value theory allows the examination of the probability distribution of extrema in data sets drawn from a particular distribution. For example FIG. 1 of the accompanying drawings illustrates a Gaussian distribution labelled p(x) of one dimensional data x (i.e. a univariate unimodal distribution) in the solid line with corresponding extreme value distributions (EVD) labelled p^{e}(x) for data sets having different numbers of samples n=10, 100, 1000. Thus the extreme value distribution gives the probability of each value of x appearing as an extremum in a set of n data points drawn randomly from the Gaussian distribution. The shape of the extreme value distribution can be understood by considering that points which are at the centre of the Gaussian distribution are very unlikely to appear as extrema of a data set, whereas points far from the centre (the mode) of the Gaussian are quite likely to be extrema if they appear in the data set, but they are not likely to appear very often. Thus as illustrated the form of the EVD is that it takes low values at the centre and edge of the Gaussian with a peak between those two areas. The particular shape of the curve for a Gaussian distribution of data is a Gumbel distribution.

By examining the extreme value distribution it is possible to use it to classify data points as normal or abnormal. It is possible, for example, to set a threshold on the extreme value distribution, for example at 0.99 of the integrated extreme value (e.g. Gumbel) probability distribution, which can be interpreted as meaning that out of a set of n actual measurements on the system, if the extremum of those measurements is outside the threshold, this has less than a 1% chance of being an extremum of a data set of n measurements of a normal system. Consequently, that measurement can be classified as indicating abnormality.

This approach still, however, looks at individual measurements (i.e., it makes point-by-point assessments, at the sampling rate of the data, which could be very high).

The present invention takes a different approach in order to classify a system state as normal or abnormal based on a time-series of measurements. That is to say, instead of regarding each point (whether the point is defined by a single variable or multiple different variables) as normal or abnormal, the invention looks at whether the time-series of measurements (taken as a single object) is normal or abnormal. This allows the detection of abnormal trajectories through the data space, even though the individual points on the trajectory may all be in a normal region of the data space.

With the present invention, therefore, a time-series of, say, n measurements is regarded as a function whose shape is to be compared with a model of normality representing normal shapes for that function. In one embodiment, this is achieved by considering the n measurements as being generated by a Gaussian Process which is a function defined by a mean function and a covariance function as explained in more detail below. Each time-series of n data points can be regarded as a single point in an n-dimensional function space and the modelling of the time-series as a Gaussian Process allows a training set of multiple normal time-series to be used to calculate a probability distribution, defined by the mean and covariance functions of the Gaussian Process, over the n-dimensional function space. This probability distribution represents the model of normality. A new time-series of m measurements can then be regarded as a point in that n-dimensional function space and a probability can be calculated from the probability distribution to indicate how likely it is that the new time-series of measurements corresponds to a time series that could be drawn from the model of normality. A threshold can be set on that probability to allow the classification of the system state as defined by the time-series of n new measurements as normal or abnormal.

Thus, the present invention provides a method of monitoring a system to classify states of the system as normal or abnormal, comprising the steps of:
obtaining a time series of measurements of the system state,
defining as a test function the time series of measurements,
obtaining a model which defines a probability distribution over functions each function consisting of time series of measurements of a system in a normal state;
comparing the test function to the model to obtain a probability that the test function corresponds to the model; and
classifying the system as abnormal if the obtained probability for the test function is lower than a predetermined probabilistic threshold.

The system can be a human or animal with the measurements being vital signs measurements such as breathing rate variability, breathing rate, heart rate, blood pressure, etc. or the system can be a machine or industrial system (such as a plant or factory). Each measurement can be the measurement of one parameter, or could be a vector x whose components are readings at the same time from different sensors. However it should be noted that the dimensions of the function space are the different times at which measurements are made so that a time series of n measurements at times t₁, n-dimensions.

Preferably, the model of normality is a Gaussian Process and the model is constructed by estimating the parameters of the Gaussian Process which give the best fit to a training set of measurements of a system or systems judged to be in a normal state.

The probability distribution over function space is preferably a multivariate Gaussian with a number of variables equal to the number of measurements in the time-series (which can be very large).

In the event of a test function which comprises a number of measurements less than the number used to define the functions in the model of normality, the model of normality can be marginalised with respect to the missing measurements and the probability for the test function calculated after marginalisation. This gives the advantage that the invention is applicable to incomplete time-series of measurements.

Rather than simply judging the probability that the test function corresponds to the model, in the case of continuous system monitoring generating a plurality of sets of time-series (i.e. a plurality of test functions), in one embodiment of the invention the most extreme of those test functions can be taken and compared to an extreme probability distribution for the model of normality to derive a probability that the extreme test function appears as an extremum of a set of functions of that size. A threshold may be set on this extreme probability to classify the system as abnormal if the probability of the extreme test function appearing as an extremum is sufficiently low. Preferably the most extreme of the test functions is regarded as the one with the lowest probability density in the function space.

The invention also provides a corresponding system monitor. The invention may be embodied in computer software adapted to execute the method on a programmed computer system.

The invention will be further described by way of example with reference to the accompanying drawings in which:-

FIG. 1 illustrates a Gaussian PDF p(x) of data x together with the corresponding extreme value distribution (EVD) pₑ(x);

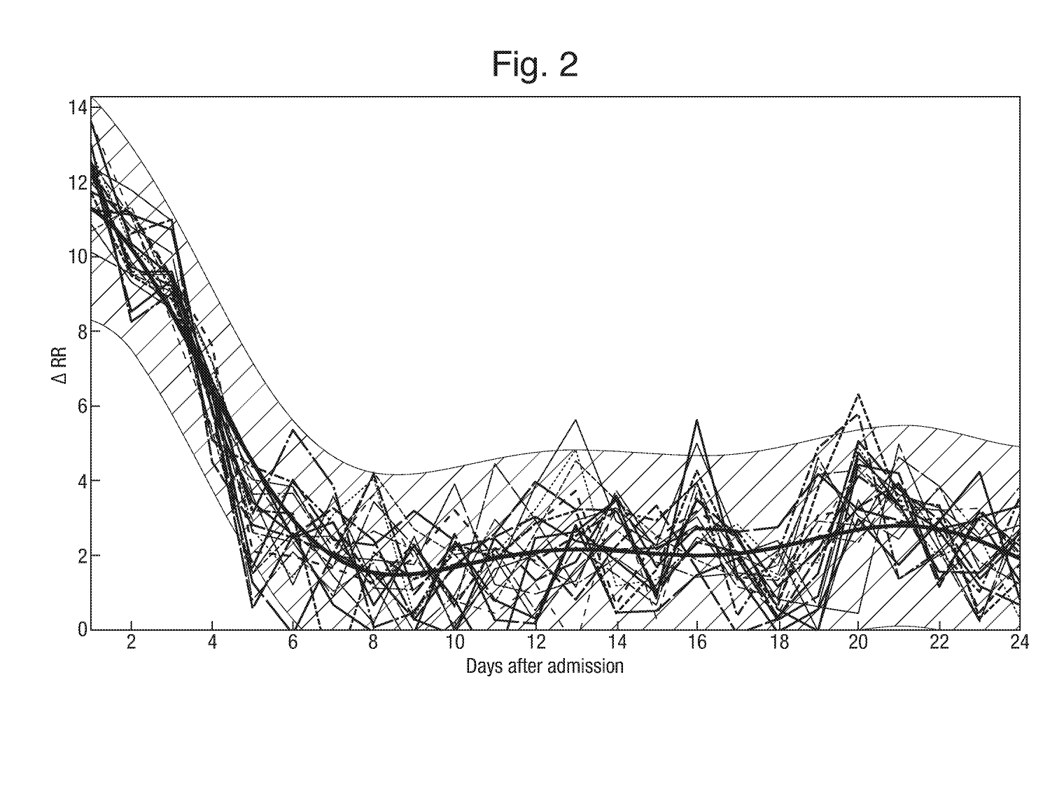

FIG. 2 illustrates an exemplary training data set comprising 27 time-series of measurements of respiratory rate variability over 24-day periods;

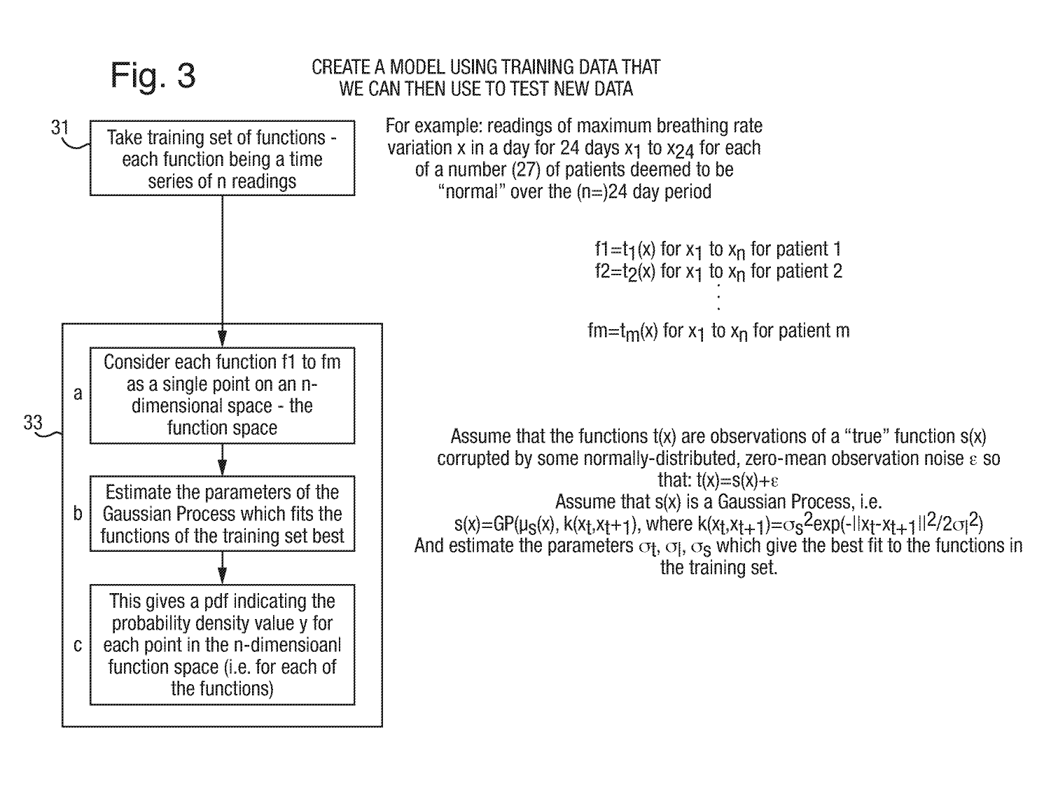

FIG. 3 schematically illustrates a process of constructing a Gaussian Process model in accordance with an embodiment of the invention;

FIG. 4 illustrates a comparison of a test function to a model of normality in accordance with an embodiment of the invention;

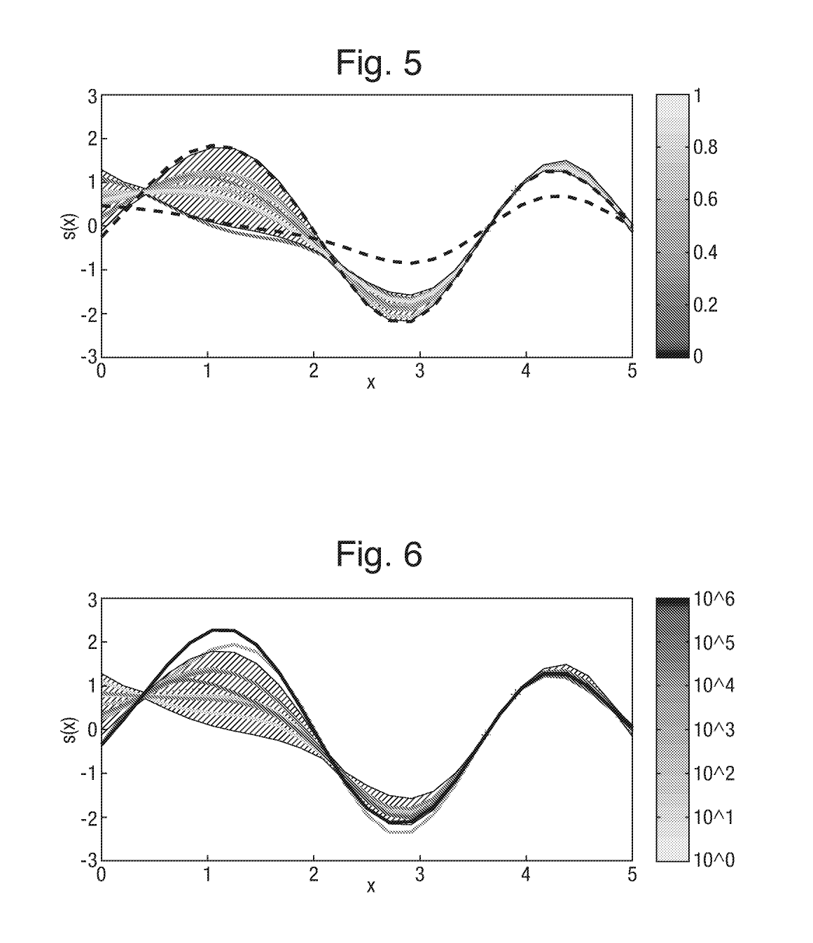

FIG. 5 shows ten sample functions (solid lines) drawn from an example Gaussian Process Model together with two other functions for comparison (dotted lines);

FIG. 6 illustrates the most extreme of several different sized sets of functions sampled randomly from the Gaussian Process Model;

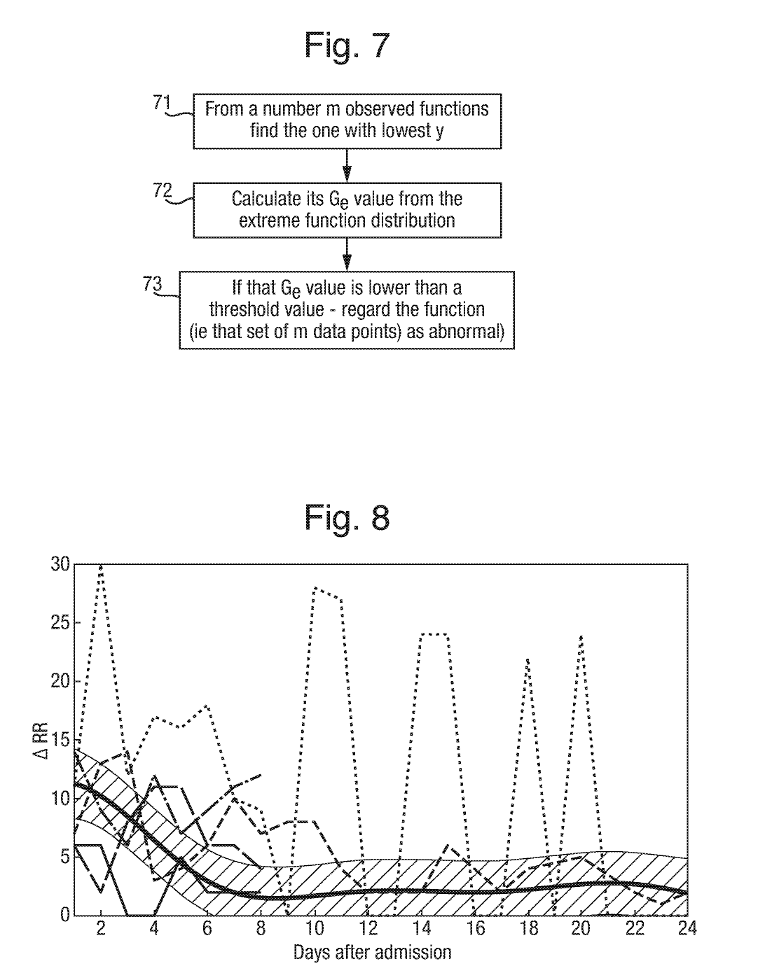

FIG. 7 illustrates how the system can be classified as normal or abnormal by reference to an extreme function distribution; and

FIG. 8 illustrates a time-series of respiratory rate variability measurements for five “abnormal” patients along with the model of normality derived from the training set of data illustrated in FIG. 2.

An embodiment of the invention will be explained with reference to monitoring a patient's vital signs data, in this case the maximum variability in respiratory rate (RR) in a day (i.e. maximum recorded respiration rate in the day minus the minimum recorded respiration rate in the day). Thus, each time-series of data is formed by one reading per day for, for example, 24 days, for one patient.

However, the invention is applicable to other sets of measurements, for example time-series of readings for machines or industrial systems or time-series of different measurements on humans or animals. It is also applicable to data series which are not time-series as the invention allows any function (whether it is a time-series or other series) to be compared to a model of normality and classified as abnormal or normal with respect to that model.

As an example, FIG. 2 shows a data set comprising 27 time-series of measurements of respiratory rate variability over the first 24 days after admission to a recovery ward after the patients have undergone upper gastro-intestinal cancer surgery. Thus, each data set represents 24 individual measurements for one patient.

These time-series are taken to represent a training set as each of these patients was assessed to have undergone a normal recovery process over the 24 day period. This training data set was used to construct a Gaussian Process model M of which the posterior mean function is shown by the solid thick line and the 95% confidence region is shaded. It should be noted that here the training time series all comprise 24 data points, where those data points occur at the same time. However, this is not a necessary constraint: the training time series may comprise different numbers of data points, and those data points may occur at different times in the different time series.

FIG. 3 schematically illustrates the process of constructing the Gaussian Process model. In step 31, the training set of functions is taken (in this case the 27 functions plotted in FIG. 2) and the parameters of the Gaussian Process which gives the best fit for the functions of the training set are obtained in step 33. A Gaussian Process is defined by a mean function and covariance function and in this embodiment, the actual measurements t(x) plotted in FIG. 2 are regarded as being observations of a true value of the respiratory rate variation s(x) corrupted by some normally-distributed, zero-mean observation noise £ such that:-

t(x)=s(x)+ε, where ε=N(0,σₜ²) (1)

The Gaussian Process is defined by:

s(x)˜GP(μₛ(x),k(x,x′)) (2)

where μₛ(x) is the mean function and k(xₜ, xₜ₊₁) is a suitable covariance function for the various different pairs of values (written as x and x′) in the time-series (e.g. xₜ and xₜ₊₁, xₜ and xₜ₊₂ etc). A suitable function is a squared exponential covariance function:

$$k ( x , {x}^{′} ) = {σ}_{s}^{2} exp ( - \frac{{‖ x - {x}^{′} ‖}^{2}}{2 {σ}_{1}^{2}} ) \qquad ( 3 )$$

Where ∥. ∥ is the 1₂ norm and where σₗ and σₛ are the length-scale in the x-direction and the variance of s(x) respectively. For a 24 point time series this function can be used to generate a 24×24 matrix Σ of covariance values k_{1,1} to k_{24,24}.

Thus, the Gaussian Process is completely defined by the three variance hyperparameters σ₁, σₜ and σₛ together with the mean function μₛ (taken to be zero in this embodiment). Estimating the values of these parameters is equivalent, as indicated in steps 33a and b, to considering each function (of, in this case, 24 readings) as a single point in a 24-dimensional space (the “function space”) and fitting a Gaussian distribution to it. There are a number of known ways of estimating the parameters of a Gaussian Process from a training set, for example by maximising the joint likelihood of all the training time-series, but other estimation techniques such as Bayesian estimation or use of a mixture of Gaussian Processes are also possible. The result in step 33c is a probability density function ƒₙ(s) which indicates the probability density value y of any point in the n-dimensional (24-dimensional in this example) function space, each point in that space defining a function s consisting of 24 successive x values.

The Gaussian Process defined by the mean and covariance functions then constitutes a model of normality for this type of system (in this case patients in the first 24 days of recovery from this type of surgery). A new series of readings, constituting a new test function, can then be compared to this model of normality to judge whether or not it is normal or abnormal. Thus, in this example a newly admitted patient would be monitored for 24 days in the same way and their readings form a function t(x) which is compared to the model of normality. FIG. 4 illustrates how this comparison takes place.

Firstly, in step 41 the same number of data points in the test series as were used in the training process (24 in this case) are taken. It should be noted that the method can be applied where the number of measurements in the test function is different and this will be explained below. The series of n data points can then be considered as a point in the n-dimensional function space and the probability density value y for this point read-off the model. However, what is wanted for classification as normal or abnormal is not a probability density value (which scale with dimensionality N), but a probability. The probability is calculated by integrating over the probability density function over a region (R) from minus infinity up to the probability density value of the test function y (or from the mode of the probability density function down to the probability density value y) to obtain a probability value G(y):

Gₙ(y)=∫_{R}ƒₙ(s)ds (4)

This integral over a multivariate (24 dimensions in this example) Gaussian is the tail mass associated with the points having a lower probability density than the test function and is thus the probability of observing a sample function with a greater distance from the mode (i.e. lower probability density value) than the test function.

In this embodiment, rather than calculating the integral each time a test function is to be evaluated, the probability function Gₙ(y) is calculated from the model of normality using integration by parts to obtain two functions for G one appropriate for even values of n (written as 2p) and one for odd values of n (written as 2p+1):-

log G₂ₚ(z)=z+log H₁(z)

log G₂ₚ₊₁(Z)=z+log H₂(Z)+log [1+exp(log H₃(z)−log H₂(z)−z)] (5)

Where z=log y as the values of y are very small so it is convenient to take their logs for the calculation.

The values of H are:

$$\begin{matrix} {H}_{1} ( z ) = {\sum }_{k = 0}^{p - 1} {{A}_{2 p}^{k} ( B - 2 z )}^{p - k - 1} & ( 6 ) \\ {H}_{2} ( z ) = {\sum }_{k = 1}^{p - 1} {{A}_{2 p + 1}^{k} ( B - 2 z )}^{p - k - \frac{1}{2}} & ( 7 ) \\ {H}_{3} ( z ) = erfc ( \sqrt{\frac{B}{2} - z} ) \\ Where \text{:} \\ {A}_{2 p}^{k} = {Ω}_{2 p} \frac{{2}^{k} ( p - 1 ) !}{( p - 1 - k ) !} {Π}_{i = 1}^{n} {L}_{i , i} , {A}_{2 p + 1}^{k} = {Ω}_{2 p + 1} \frac{( 2 p - 1 ) ! ( p - k ) !}{{2}^{k - 1} ( p - 1 ) ! ( 2 p - 2 k ) !} {Π}_{i = 1}^{n} {L}_{1 , 1} \\ B = - 2 log {C}_{n} = - n log ( 2 π ) - 2 {\sum }_{i = 1}^{n} log {L}_{i , i} \\ {Ω}_{n} = \frac{{( 2 Π )}^{n / 2}}{Γ ( \frac{n}{2} )} & ( 8 )\end{matrix}$$

where ┌(.) is the Gamma function, erfc(.) is the complementary Gaussian error function and L_{i,i} is the Cholesky decomposition of the covariance matrix of the Gaussian Process (all standard computer calculation functions). Thus G is a distribution over likelihoods y via z (=log y) and the covariance matrix of the Gaussian Process estimated from the training set.

Thus, the value of y from the test function is used in Equations 6 to 8 to calculate H₁ and H₂ and H₃ which are then used in Equation 5 to calculate the probability G. Having calculated the probability for the test function (more accurately this is the probability that a sample function randomly drawn from the model of normality would have a lower probability density value y than this test function), this probability can be compared to a predefined probabilistic threshold to classify the test function as normal or abnormal. For example, if the threshold is set as 0.05 and the test function has a probability G less than this it means that the test function could have been generated from the Gaussian Process model of normality with a probability less than 5%.

FIG. 5 shows an example in which ten sample functions s(x) (solid lines) have been drawn from an example Gaussian Process Model and which are therefore all “normal” and where two other functions have been shown for comparison (dotted lines). Each of the sample functions has a different value of probability G with those functions that lie close to the mean function taking higher values of G and those that stray away from the mean function taking lower values. All of the normal sample functions, in this case, take values of G greater than 0.15 and so a normality threshold based on a value of 0.05 would regard these functions as normal. The two functions shown by dashed lines, however, have values of G less than 10⁻³ and so fall below the 0.05 threshold and would be regarded as abnormal.

As mentioned in the introduction, one problem with continual system monitoring is that the longer the system is observed, the more likely it is that an observation further from the mean will be seen (in other words the most likely value of an extremum of a data set increases with the size of the data set) despite the fact that the system may still be normal. It is possible to extend the ideas of extreme value distributions to the concept of probability distributions over functions developed above. Thus, given the model of normality, it is possible to derive from it the probability distribution of extrema (in this case extreme functions) for sets of different numbers of functions drawn from it.

FIG. 6 illustrates functions sampled randomly from the Gaussian Process Model constructed above, where each of the plotted functions is the most extreme of a set of m sample functions, for increasing m, where “most extreme” is defined as the function with the lowest probability density y as given by the n-dimensional multivariate Gaussian distribution over the training set in function space. As m increases the most extreme function observed in a set of m randomly-generated functions becomes increasingly more extreme, moving away from the mean function. However, they are all “normal” functions in that they have been generated from the model of normality and so should be classified as normal. Thus, they are extreme, but not abnormal—they are extreme only because many realisations from the model have been observed.

Given the distribution function G(y), which is itself univariate in densities y, the most extreme sample of a set of observations from G(y) has a probability density which converges to the Weibull distribution:

$${G}_{n}^{e} ( y ) = 1 - exp [ - {( \frac{y}{{c}_{m}} )}^{{α}_{m}} ] \qquad ( 9 )$$

The scale and shape parameters cₘ and αₘ can be estimated from G(y) by:

cₘ=Gₙ^{←1/m} which is the 1/m quantile on Gₙ(y)
and αₘ=mcₘgₙ(cₘ) and gₙ(y) is the pdf associated with Gₙ(y) which is:
gₙ(y)=Ωₙ(r₀)⁽ⁿ⁻²⁾Πᵢ₌₁ⁿL_{i,1} where r₀ is the Mahalanobis radius, namely r₀=\sqrt{−2 log(yCₙ)} and Cₙ=(2π)^{n/2}|K|^{1/2} (K being the covariance matrix of the Gaussian Process) which is the mode of the pdf.

Thus, given a plurality of test functions (each representing a time-series of measurements of a system), FIG. 7 illustrates how the system can be classified as normal or abnormal. Firstly, in step 71, whichever of the m test functions has the lowest probability density value y is taken and step 72 its extreme probability value G^{e}ₙ(y) can be calculated from Equation (12), this giving the probability that this test function would be observed as an extremum of m test functions drawn from the model of normality. In step 73, this value G^{e} can be compared to a threshold, (for example 0.05) and if the G^{e} value is less than 0.05, the system will be classified as abnormal. This corresponds to judging the system as abnormal if there is less than a 5% chance that a set of m functions drawn from the model of normality would have an extreme function of lower probability density value y than the test function.

FIG. 8, illustrates the time-series of respiratory rate variability measurements for five “abnormal” patients along with the model of normality derived from the training set of data illustrated in FIG. 2. These patients were judged to be abnormal by clinicians following physiological deterioration. All five of these functions have extreme probability values G^{e} less than 0.05 and are thus correctly classified as abnormal. It should be noted that this correct classification is achieved despite some of the functions showing individual respiratory rate variability values within the normal range for patients in recovery.

In the example above, the test function was assumed to have the same number of readings (24 in the example above) as the data in the training set. However, an advantage of the present invention is that test functions which have fewer data points can still be consistently compared to the model of normality. This is achieved by marginalisation of the Gaussian distribution, in the case of the Gaussian Process defined by a matrix of mean values and a covariance matrix, this simply involves eliminating the mean and covariance row and column for the missing data values. This marginalises out of the model the missing data values allowing comparison of the test function with fewer values to the marginalised model.

In summary, therefore, with the invention a method of monitoring a system such as a machine, industrial system, or human or animal patient, to classify the system as normal or abnormal, uses a time-series of measurements of the system which are regarded as a function to be compared to a model of normality for such functions. The model of normality can be constructed as a Gaussian Process and test functions compared to the model to derive the probability that they are drawn from the model of normality. A probability distribution for the expected extrema of sets of functions drawn from the model can also be derived and the probability of any extremum of a plurality of test functions being an extremum of a set derived from the model of normality can be obtained. The system can be classified as normal or abnormal based on the extreme probability distribution. Test functions with fewer data points can be compared to the model of normality by marginalisation with respect to the missing data points.

1. A method of monitoring a system to classify states of the system as normal or abnormal, comprising the steps of:
obtaining a time series of measurements of the system state,
defining as a test function the time series of measurements,
obtaining a model which defines a probability distribution over functions each function consisting of time series of measurements of a system in a normal state;
comparing the test function to the model to obtain a probability that the test function corresponds to the model; and
classifying the system as abnormal if the obtained probability for the test function is lower than a predetermined threshold.

2. A method according to claim 1 wherein the model is a Gaussian Process.

3. A method according to claim 1 wherein the probability distribution over functions is a multivariate Gaussian with number of variables equal to number of measurements in the time series.

4. A method according to claim 1 wherein when the test function has missing measurements compared to the time series defining the model, the probability distribution is marginalised with respect to missing measurements.

5. A method according to claim 1 wherein an extreme function distribution is defined with respect to the model and said step of comparing the test function to the model to obtain a probability comprises comparing the most extreme of a plurality of test functions to the extreme function distribution to obtain an extremum probability that the most extreme function appears as an extremum of a corresponding plurality of functions drawn from the model.

6. A method according to claim 5 wherein said extremum probability is compared to threshold and if it is lower than the threshold the system is classified as abnormal.

7. A method according to claim 1 wherein the system is human or animal and the measurements are vital signs measurements.

8. A method according to claim 1 wherein the system is a machine or industrial plant.

9. A system monitor comprising an input for receiving a time series of measurements of the system state, a processor adapted to execute the method of claim 1, and an output for outputting the classification result.

10. A computer program comprising program code means for executing on a programmed computer system the method of claim 1.
